(19) United States
(12) Patent Application Publication
(10) Pub. No.: US 2025/0196964 A1
(43) Pub. Date: Jun. 19, 2025

(54) HYDRAULIC BRAKE CONTROL UNIT AND HANDLEBAR ASSEMBLY

(71) Applicant: RAICAM DRIVELINE S.R.L., Mondovi' (Cuneo) (IT)

(72) Inventors: Sandro BONARDO, Peveragno (Cuneo) (IT); Matteo GIACCARDI, Piozzo (Cuneo) (IT)

(73) Assignee: RAICAM DRIVELINE S.R.L., Mondovi' (Cuneo) (IT)

(21) Appl. No.: 18/851,724

(22) PCT Filed: Mar. 29, 2023
(86) PCT No.: PCT/IB2023/053117

§ 371 Date: Sep. 27, 2024

(30) Foreign Application Priority Data
Mar. 31, 2022 (IT) 102022000006374

(51) Int. Cl. B62K 21/12; B62L 3/02

(52) U.S. Cl. CPC B62K 21/12; B62L 3/023

(57) ABSTRACT

A hydraulic brake control unit for a handlebar-guided vehicle which has a cartridge mounted in a handlebar tube of the vehicle and forming an inner longitudinal cavity with a port at one end thereof, a piston housed in the longitudinal cavity and a transmission lever rotatably mountable on the handlebar tube is provided. The transmission lever acts between a brake control lever and the piston by exerting a thrust on the piston towards the port in a first longitudinal direction. A channel, formed in the cartridge, determines a U-shaped path for a brake fluid by fluidically connecting the port of the longitudinal cavity and a hydraulic hose, so as to exert a pressure on the brake fluid contained in the hydraulic hose in a second longitudinal direction, opposite to the first longitudinal direction.

### TECHNICAL FIELD

The present invention pertains to the field of handlebar-guided vehicles equipped with a hydraulic brake. The invention refers to an integrated control unit for a hydraulic brake of a handlebar-driven vehicle. More particularly, but not exclusively, the present control unit is applicable to bicycles.

### BACKGROUND ART

As known, many bicycles and other handlebar-driven vehicles are equipped with a hydraulic braking system, wherein a brake master cylinder, actuated by a brake control lever on the handlebar, controls a brake caliper associated with each wheel via a hydraulic hose. The master cylinder and an associated tank containing a reservoir of brake fluid are mounted on the handlebar near the control lever. The hose runs externally along the handlebar.

US 2019/0152457 A1 discloses a control unit for a hydraulic brake or clutch of a handlebar-driven vehicle. A brake master cylinder is arranged inside a handlebar tube; a hydraulic hose is hydraulically connected to the master cylinder and runs internally within the handlebar tube. A hand control lever, external to the handlebar, is pivotally connected to a piston in the master cylinder via a tie rod drive element which exerts a pulling force on the piston when the control lever is actuated.

### SUMMARY OF THE INVENTION

The present invention provides a master cylinder control unit integrated in a handlebar tube of a vehicle equipped with a hydraulic braking system, wherein a brake fluid hose runs inside the handlebar tube.

Objects of the invention are to provide a compact control unit, reliable in operation, easy to assemble in a handlebar tube, and preferably offering the possibility of modulating, according to requirements, the braking load curve in different braking stages.

The above and other objects and advantages, which will be better understood hereinafter, are accomplished, according to the present invention, by a hydraulic brake control unit having the features set forth in the appended claims.

In summary, a hydraulic brake control unit comprises a cartridge configured for being mounted inside a handlebar tube. The cartridge forms an inner longitudinal cavity with a port at one end thereof. A longitudinally movable piston is partially accommodated in the longitudinal cavity. A transmission lever, which can be pivotally mounted on the handlebar tube about a transversal axis, acts between the brake control lever and the piston to exert a thrust on the piston towards said port, in a first longitudinal direction. Within the cartridge a channel is formed which determines a U-shaped path for the brake fluid, wherein the channel fluidically joins said port of the longitudinal cavity to a hydraulic hose which is also accommodated in the handlebar tube.

Preferred embodiments are set forth in the dependent claims.

### BRIEF DESCRIPTION OF THE DRAWINGS

A few preferred but non-limiting embodiments of a hydraulic brake control unit according to the invention will now be described; reference is made to the attached drawings, in which:

FIG. 1 is a cross-sectional view of a hydraulic brake control assembly integrated in a handlebar tube of a handlebar-guided vehicle, with a manual control lever;

FIG. 2 is a cross-sectional view, similar to that of FIG. 1, but taken according to a different section angle;

FIG. 3 is another cross-sectional view, similar to those of FIGS. 1 and 2, but taken according to a still different section angle; and

FIG. 4 is a cross-sectional view, to an enlarged scale, of a detail of FIG. 1.

### DETAILED DESCRIPTION

With reference to the drawings, a control unit for a hydraulic brake of a handlebar-guided vehicle, in particular (but not exclusively) a bicycle, is integrated in a handlebar tube 10, and more particularly in a straight end portion of the handlebar tube 10.

The handlebar tube 10 identifies a central axis x, herein referred to as “longitudinal”. In the present description and in the annexed claims, terms indicating orientations and directions, such as “longitudinal”, “transversal”, “external” and “internal”, are to be construed with reference to the longitudinal axis x, unless otherwise noted.

A brake control lever 11 is mounted on the handlebar tube 10 so that it can rotate about an axis 11a a transversal to the longitudinal axis x.

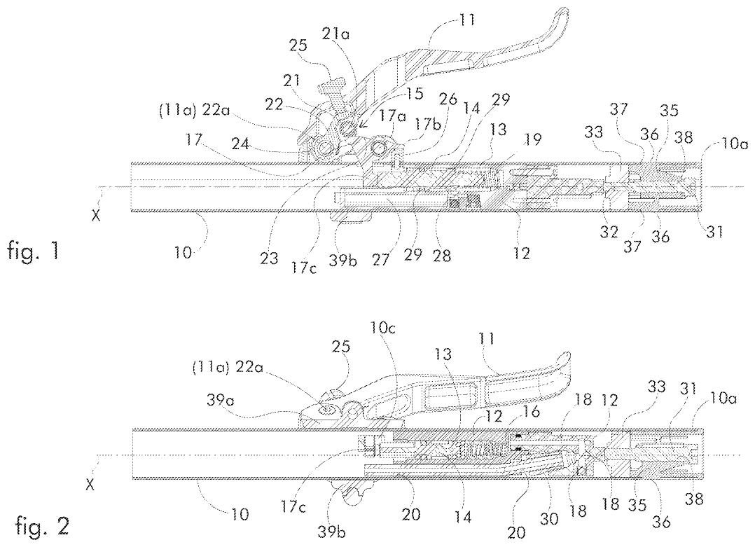

Inserted inside the handlebar tube 10 and tightly fitted therein is a cartridge 12, which forms inside it a longitudinal cavity 13 with a port 16 located (FIG. 2) at one end of the cavity 13 and facing in use an end 10a of the handlebar tube (to the right in FIGS. 1 to 3). The port 16 serves as a passage for brake fluid used for operating the hydraulic brake.

A piston 14 is partially housed, in a longitudinally movable manner, in the longitudinal cavity 13. The piston 14 can be actuated by the brake control lever 11 through a transmission mechanism 15 which comprises a transmission lever 17 mounted on the handlebar tube 10 so that it can rotate about a transversal axis 17a.

According to an embodiment, the transmission lever 17 is made as a rocker arm, and has an arm 17c which penetrates inside the handlebar tube 10 through an opening 10c and is engaged against one end of the piston 14 that is the farther from the port 16.

The transmission lever 17 can be operated by the brake control lever 11 to exert a longitudinal thrust action on the piston, causing it to advance in the longitudinal cavity 13 towards the port 16, in a first direction or longitudinal direction.

Within the longitudinal cavity 13, a compression spring 19 is interposed between the piston 14 and the bottom of the longitudinal cavity 13, on the side of the port 16. The spring 19 urges the piston 14 away from the port 16.

Within the cartridge 12 there is provided a channel 18 which forms a U-shaped path for the brake fluid; the channel 18 extends from the port 16 to a hydraulic hose 20 which is accommodated within the handlebar tube 10 and extends in a second longitudinal direction or in the direction opposite to the first actuation direction of the piston 14, to transmit to a hydraulic caliper (not shown) the pressure imparted by the piston 14 when the brake control lever 11 is operated.

For constructional reasons, the cartridge 12 may be composed by joining several parts. The cartridge 12 may be made of plastic material, or of a metallic material, such as aluminium or alloys thereof.

According to an embodiment, the transmission mechanism 15 may also comprise an intermediate lever 22, mounted in rotatable manner on the brake control lever 11 about a transversal rotation axis 22a.

In accordance with the particular embodiment illustrated herein, the intermediate lever 22 is mounted on the handlebar tube 10 in a rotatable manner about a transversal rotation axis 22a coinciding with the transversal axis 11a about which the brake control lever 11 is pivotally mounted.

A wheel 21, which can rotate freely about a transversal rotation axis, is mounted in this example on the intermediate lever 22.

When the brake control lever 11 is actuated, pulling it towards the handlebar tube 10, the wheel 21 acts in a thrust relationship by rolling against and along a surface 23 of the transmission lever 17.

The intermediate lever 22 is urged, together with the brake control lever 11, by a spring 24 which tends to bring the brake control lever 11 closer to the handlebar tube 10, simultaneously urging also the intermediate lever 22 against an adjusting screw 25 mounted on the lever brake control knob 11.

The adjusting screw 25, which is optional, serves to adjust the rest position of the brake control lever 11, in accordance with the size of the user's hand, in particular according to the length of the user's fingers. When the brake control lever 11 is pulled towards the handlebar tube 10, the intermediate lever 22 is urged by the adjusting screw 25 and rotated counterclockwise about the axis 22a.

In an alternative embodiment (not shown), the wheel 21 may be rotatably mounted directly on the brake control lever 11. In such an embodiment, the intermediate lever 22 and the adjusting screw 25 are absent.

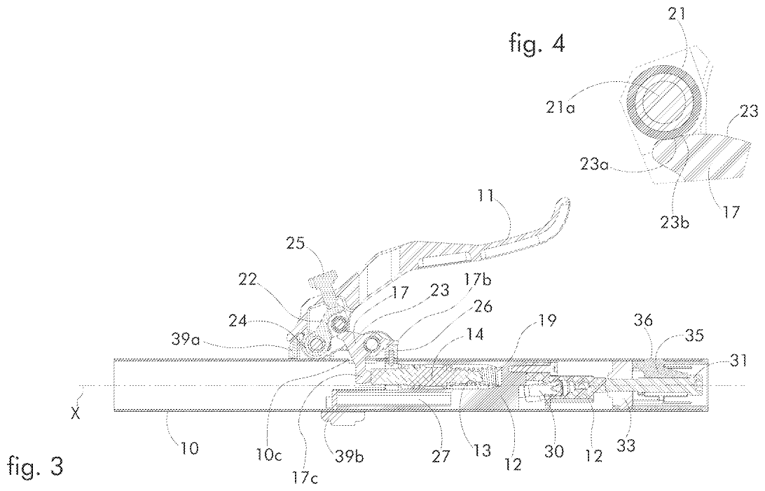

According to a preferred embodiment, a stopping element 26 (FIGS. 1 and 3) may be fixed on the handlebar tube 10 in a stable position with respect to the cartridge 12, and cooperates, in the rest or non-actuated position of the brake (FIGS. 1 and 3), with a protrusion 17b of the transmission lever 17 for determining the end of stroke position of the piston 14 at the opposite end with respect to the end providing the port 16 for the brake fluid. In the end-of-stroke position (illustrated in FIGS. 1 and 3), the thrust exerted by the spring 19 on the piston 14 is discharged onto the transmission lever 17, the rotation of which is blocked by the stopping element 26.

The cartridge 12 is inserted into the handlebar tube 10 through the open end (on the right) of the handlebar tube until the piston 14 abuts against the arm 17c of the transmission lever 17 in a stop position determined by the protrusion 17a resting against the stop element 26.

According to a preferred embodiment, the cartridge 12 further forms a reservoir 27 (FIGS. 1 and 3) for the brake fluid, also housed inside the handlebar tube 10, and communicating fluidically with the longitudinal cavity 13 through a passage bore 28 (FIG. 1).

In a per se known manner, one or more annular gaskets 29 are mounted on the piston 14, the longitudinal position of which, with respect to the passage bore 28, determines the so-called “dead stroke”, i.e. the length of the initial stretch covered by the piston, during which the movement of the piston does not cause an outflow of brake fluid from the longitudinal cavity 13 through the port 16.

Preferably, the channel 18 within the cartridge 12 is connected to the hose 20 by a high-pressure connector 30 (FIG. 2).

According to an embodiment, a longitudinal adjustment screw 31 is provided, acting on one end of the cartridge 12, to adjust the relative longitudinal position of the cartridge with respect to the piston 14. By adjusting the relative rest position between the seals 29 on the piston 14 and the passage bore 28 in cartridge 12, the length of the “dead stroke” of the piston is adjusted accordingly.

In the illustrated embodiment, the adjustment screw 31 engages through a central threaded hole 32 obtained in a rigid disc plug 33, preferably metallic, which may be fixed inside the handlebar tube 10.

According to an embodiment, the longitudinal position of the rigid disc plug 33 within the handlebar tube 10 is determined by a shoulder provided by a locking element 35 inserted in the handlebar tube 10 and preferably made of plastic material.

The locking element 35 may be provided with peripheral teeth 36 which can snap into and engage respective through openings 37 formed through the handlebar tube 10. The locking element 35 serves as a shoulder surface for the rigid disc plug 33 and has a central hole 38 passing through and adapted to receive the adjustment screw 31.

Preferably, the central hole 38 is at least partially aligned in a transverse plane with the peripheral locking teeth 36. Due to this arrangement, the presence of the central adjustment screw 31 in the centre of the locking element 35 prevents unwanted disengagement of the peripheral teeth 36 from the openings 37 in the handlebar tube 10. The brake control lever 11 is in this example mounted on the handlebar tube 10 by means of two complementary assembly half-rings 39a, 39b (FIG. 2).

During use, by actuating the brake control lever 11, i.e. pulling it in a per se known manner towards the handlebar tube 10, the brake control ever 11 rotates clockwise (FIG. 1), also causing the (optional) intermediate lever 22 to clockwise rotate with it. The wheel 21, rolling along the shaped surface 23 of the transmission lever 17, causes the latter to rotate counterclockwise, urging the piston 14 to the right, in an actuation direction towards the end of the handlebar, and pushing towards the port 16 an amount of brake fluid which fills the cavity 13. Through the channel 18, the brake fluid performs a U-turn of its path and is introduced into the flexible hose 20 and from here is delivered towards the brake caliper (not shown) on a wheel of the vehicle.

The shape of the surface 23 of the transmission lever 17 on which the wheel 21 rolls can be designed in a variable way, to modulate the load/stroke curve of the piston according to the needs. It is possible to adjust the inclination of the rolling surface 23 for the wheel in such a way that, at the same angle of rotation performed by the intermediate lever 22, a greater or lesser angle of rotation of the transmission lever 17 is achieved, and therefore a longer or shorter linear stroke of the piston 14. This arrangement allows for a more or less accentuated stroke progression of the piston which changes during the stroke of the piston, for example becoming increasingly unfavorable as the brake control lever 11 is pulled, that is, as it approaches its end-o-stroke. For example, the surface 23 may be configured and variously inclined in such a way that, with equal reaction given by the spring 19, the user can feel that the brake control lever 11 becomes progressively harder to pull, as it gradually approaches the handlebar tube when the brake is operated.

According to an embodiment (FIG. 4), the surface 23 of the transmission lever 17 may have a slight recess 23a, preferably having a curvature corresponding to the curvature of the wheel 21, which serves as a seat for steadily receiving the wheel 21 in the non-actuated position of the brake. The recess 23a may be radiused to the rest of the surface 23 with a slight bump 23b, giving the user the ergonomically advantageous sensation of a jerk at the start of braking.

The adjusting screw 31, in addition to allowing adjustment of the longitudinal position of the cartridge 12 and of the cavity 13 with respect to the piston 14, thus also allowing adjustment of the length of the dead stroke, represents a stable shoulder surface which prevents the cartridge 12 from being ejected through the end (on the right) of the handlebar tube 10, due to the effect of the hydraulic thrust exerted by the piston 14, when it is operated.

While specific embodiments of the invention have been disclosed, it is to be understood that this disclosure has been provided for illustrative purposes only and that the invention is not to be limited by it in any way. Various modifications will be apparent to those skilled in the art, in the light of the previous examples. The scope of the invention is limited only by the appended claims.

1. A hydraulic brake control unit for handlebar-guided vehicles having a handlebar tube containing a hydraulic hose, the hydraulic brake control unit comprising:
a cartridge configured for being mounted inside the handlebar tube, the cartridge forming internally a longitudinal cavity with a port at one end thereof;
a piston partially accommodated in the longitudinal cavity;
a transmission lever, rotatably mountable on the handlebar tube about a transverse axis, the transmission lever acting between a brake control lever and the piston to exert a thrust on the piston towards said port in a first longitudinal direction; and
a channel formed within the cartridge, determining a U-shaped path for a brake fluid, the channel fluidically joining the port of the longitudinal cavity and the hydraulic hose, in such a way as to exert a brake actuating pressure on the brake fluid contained in the hydraulic hose in a second longitudinal direction, opposite to the first longitudinal direction.

2. The hydraulic brake control unit of claim 1, further comprising a roller rotatable around a transverse axis and mountable on the brake control lever, wherein the roller acts by rolling along a surface of the transmission lever when the brake control lever is actuated.

3. The hydraulic brake control unit of claim 2, wherein the surface of the transmission lever has a variable inclination to provide a desired load/piston stroke diagram.

4. The hydraulic brake control unit of claim 2, wherein said surface has a recess for stably receiving the roller in a non-actuated condition of a brake.

5. The hydraulic brake control unit of claim 1, further comprising a stopping element fixable on the handlebar tube and cooperating with a portion of the transmission lever to determine an end-of-stroke position of the piston from a side of the piston furthest away from said port.

6. The hydraulic brake control unit of claim 2, wherein the roller is mountable directly on the brake control lever or on an intermediate lever, wherein the intermediate lever is rotatably mountable about a transverse axis on the handlebar tube or on the brake control lever, and wherein an angular position of the intermediate lever with respect to the brake control lever is adjustable by an adjusting screw.

7. The hydraulic brake control unit of claim 1, wherein the transmission lever is made as a rocker arm, and comprises an arm configured to penetrate inside the handlebar tube through an opening of the handlebar tube and engage in a thrust relationship against an end of the piston furthest from the port.

8. The hydraulic brake control unit of claim 1, wherein the cartridge further forms an internal reservoir for the brake fluid.

9. The hydraulic brake control unit of claim 8, wherein the cartridge further forms an internal passage bore setting the internal reservoir in fluid communication with the longitudinal cavity.

10. The hydraulic brake control unit of claim 1, further comprising a longitudinal adjustment screw acting against an end of the cartridge farther from the transmission lever, for adjusting a longitudinal position of the cartridge with respect to the piston.

11. The hydraulic brake control unit of claim 10, further comprising a rigid plug mountable in a longitudinally fixed manner inside the handlebar tube and having a central threaded hole in which the longitudinal adjustment screw is threadedly engaged.

12. The hydraulic brake control unit of claim 11, further comprising a longitudinal locking element comprising peripheral locking teeth adapted to engage in corresponding openings formed in the handlebar tube, the longitudinal locking element determining a longitudinally fixed shoulder surface adapted to oppose displacements of the rigid disk.

13. The hydraulic brake control unit of claim 12, wherein the longitudinal locking element comprises a central hole at least partially aligned in a transverse plane with the peripheral locking teeth and able to receive a portion of the longitudinal adjustment screw.

14. An assembly comprising a handlebar tube for a handlebar-guided vehicle and the hydraulic brake control unit of claim 1.
